(19) United States
(12) Patent Application Publication
(10) Pub. No.: US 2026/0240385 A1
(43) Pub. Date: Aug. 20, 2026

(54) APPARATUS AND METHOD FOR DUST REMOVAL

(71) Applicant: Illinois Tool Works Inc., Glenview, IL (US)

(72) Inventors: Dean Beardmore, Sydney (AU); Bryan Marshall, Sydney (AU)

(21) Appl. No.: 19/164,456

(22) PCT Filed: Mar. 21, 2024
(86) PCT No.: PCT/US2024/020943

§ 371 Date: Sep. 11, 2025

(30) Foreign Application Priority Data
Mar. 22, 2023 (AU) 2023900804

(51) Int. Cl. A47L 7/00; A47L 9/06; A47L 9/08; B23Q 11/00

(52) U.S. Cl. CPC A47L 7/0095; A47L 9/0693; A47L 9/08; B23Q 11/006; B23Q 11/0075

(57) ABSTRACT

An apparatus for dust removal from a drilled hole, including an adaptor for coupling a vacuum to the drilled hole, and a pump for pumping gas into the drilled hole to blow dust from the drilled hole, wherein the adaptor includes a directing mechanism for directing an outlet of the pump into the drilled hole.

### PRIORITY CLAIM

This application is a national stage application of PCT/US2024/020943, filed on Mar. 21, 2024, which claims priority to and the benefit of Australian Application No. 2023900804, which was filed on Mar. 22, 2023, the entire contents of each of which are incorporated herein by reference.

### FIELD

The present disclosure relates dust reduction during construction. More specifically, the present disclosure relates to airborne dust reduction in a drilling operation during construction.

### BACKGROUND

It is known to anchor objects to a substrate chemical anchoring and/or mechanical anchoring in the case of chemical anchoring this includes a chemical and a device to be secured in a drilled (example, the device being a threaded rod or reinforcing bar) in the case of mechanical anchoring, this may be achieved by way of expansion anchors or screw anchors (for example, the kinds of anchors sold under the trademarks of DynaBolt or AnkaScrew).

In both cases, with chemical anchoring and mechanical anchoring, a hole is drilled in the substrate. The applicant has determined that the quality of the anchoring may be dependent on the cleanliness of the drilled hole and, specifically, the absence of dust in the hole.

To deal with the anchorage problems associated with dust in a drilled hole, it has been previously proposed to use a dustless drilling system or a so-called “brush, blow technique”. Dustless drilling is a thorough solution but has the disadvantage of being relatively expensive, requiring special drill bits and typically an expensive plug-in vacuum system. Advantageously, with a dustless drilling system, no cleaning of the hole is required after drilling. In the “brush, blow technique”, a hole is drilled using a traditional drill, leaving a large amount of dust inside.

It has also been previously proposed to provide a dust reduction device to be used when drilling a hole. Such devices may be in the form of a dust extraction adapter which uses a vacuum to extract dust during a drilling operation. However, the applicant has identified that these devices merely reduce dust from above the substrate surface while drilling and do not clean the drilled hole. In particular, such devices allow dust to remain within the drilled hole.

The applicant has determined that it would be beneficial for there to be provided an improved apparatus for reducing airborne dust during the cleaning of holes drilled in substrates such as concrete.

Examples of the present disclosure seek to provide an airborne dust reduction or prevention apparatus which alleviates or at least ameliorates one or more disadvantages of existing methods and apparatuses used in drilling operations.

### SUMMARY

In accordance with one aspect of the present disclosure, there is provided an apparatus for dust removal from a drilled hole, including an adaptor for coupling a vacuum to the drilled hole, and a pump for pumping gas into the drilled hole to blow dust from the drilled hole, wherein the adaptor includes a directing mechanism for directing an outlet of the pump into the drilled hole.

Preferably, the directing mechanism includes an aperture in the adaptor for allowing passage of a conduit from the pump into the drilled hole. More preferably, the adaptor includes a body having a base seal for forming a seal against a surface of a substrate in which the hole is drilled. Even more preferably, the body includes an outlet coupling for coupling to a vacuum.

In a preferred form, the apparatus includes a removable cup arranged to be seated against the body, the removable cup having a central aperture arranged to surround the conduit from the pump. More preferably, the apparatus includes a compression spring around the conduit, the spring being arranged to act against the removable cup so as to bias the cup in its seated arrangement against the body.

Preferably, the conduit is provided with side apertures formed in a side wall of the conduit. More preferably, the side apertures are spaced from a tip of the conduit.

In a preferred form, the conduit has a main outlet at a distal end portion of the conduit. More preferably, the distal end portion of the conduit has at least one cutaway to prevent blockage of the conduit against an end of the drilled hole.

In one form, the conduit is rigid. In other forms, the conduit may be flexible, with or without a rigid tip. A rigid tip may assist with preventing unwanted sealing against an end of the drilled hole. More preferably, the conduit is substantially linear.

Preferably, the side apertures are arranged at spaced intervals along the length of a portion of the conduit. More preferably, the side apertures are arranged in a staged and/or spiral arrangement. Even more preferably, the side apertures are arranged at a distance from the distal tip of approximately 50 mm, 75 mm, 100 mm and/or 125 mm. The side apertures may be in the form of round holes, slots and/or other aperture shapes.

In one form, the body defines a vacuum suction chamber whereby the outlet coupling is in fluid communication with a foot of the body such that the body is held in place against the substrate by virtue of the vacuum.

In accordance with another aspect of the present disclosure, there is provided a method of drilling a hole in a substrate including the steps of providing an apparatus including an adaptor and a pump; coupling an outlet coupling of the adaptor to a vacuum; placing a foot of the adaptor to rest on a surface of said substrate; holding the adaptor in place against the substrate by operating the vacuum; arranging the pump such that a conduit of the pump extends through a body of the adaptor and terminates in the drilled hole; and operating the pump to blow dust from the drilled hole such that said dust is fed through the outlet coupling by virtue of the vacuum.

Preferably, prior to the step of operating the pump, the method further includes the step of using a drill with a drill bit of the drill extending through an aperture of the adaptor so as to form the drilled hole in the substrate. Even more preferably, the method further includes the step of blowing gas from the pump through side apertures formed in a side wall of the conduit so as to blow dust from a side wall of the drilled hole.

In accordance with yet another aspect of the present disclosure, there is provided an apparatus for dust removal from a drilled hole formed in a substrate, including an adaptor for coupling a vacuum to the drilled hole, wherein the adaptor includes a foot for standing on a surface of the substrate, the adaptor includes an outlet coupling for coupling to the vacuum, the adaptor includes a body defining a suction chamber, and wherein the body is provided with a lowered platform having an aperture formed therein, the lowered platform being lowered from a surrounding portion of the body toward the foot so as to improve visibility during drilling of the hole.

Preferably, the platform is provided with a rigid seating portion around the aperture for seating a removable cup.

### BRIEF DESCRIPTION OF THE DRAWINGS

Preferred embodiments of the present disclosure will be described, by way of non-limiting example only, with reference to the accompanying drawings in which:

FIG. 1 is a top view of an adaptor of an apparatus for dust removal in accordance with an example of the present disclosure;

FIG. 2 shows a top perspective view of the adaptor;

FIG. 3 shows an end view of the adaptor;

FIG. 4 shows a side view of the adaptor;

FIG. 5 shows an opposite end view of the adaptor;

FIG. 6 shows an underside view of the adaptor;

FIG. 7 shows a bottom perspective view of the adaptor;

FIG. 8 is a top perspective view of the adaptor shown in combination with a pump;

FIG. 9 is a side perspective view of a removable cup adapted to be seated against a body of the adaptor;

FIG. 10 is a top view of the removable cup shown in FIG. 9;

FIG. 11 is a sectional view of the removable cup taken along line A-A shown in FIG. 10;

FIG. 12 is a side view of the removable cup shown in FIG. 9;

FIG. 13 is a top perspective view of the removable cup shown in combination with a pump for blowing dust from a drilled hole;

FIG. 14 is a perspective view showing an adaptor mounted to a wall surface;

FIG. 15 is a perspective view showing an adaptor mounted to a horizontal surface;

FIG. 16 is a perspective view of an adaptor mounted to a plank of timber, which may be drilled for attachment to a substrate below;

FIG. 17 is a top perspective view of an adaptor in accordance with another example of the present disclosure;

FIG. 18 is a bottom perspective view of the adaptor shown in FIG. 17;

FIG. 19 is a cross-sectional view of the adaptor shown in FIG. 17, taken along a central longitudinal axis;

FIG. 20 is a top perspective view of the adaptor shown in FIG. 17, in combination with a cup and pump with conduit;

FIG. 21 is a top perspective view of the combination of FIG. 20, shown with the cup seated against a body of the adaptor; and

FIG. 22 shows a range of side aperture configurations for a conduit of the pump.

### DETAILED DESCRIPTION

While the systems, devices, and methods described herein may be embodied in various forms, the drawings show, and the specification describes certain exemplary and non-limiting embodiments. Not all components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

The applicant has identified that cleaning of a drilled hole is crucial to gaining effective pull-out strength when using chemical anchoring solutions and that holes should also be cleaned when using mechanical anchoring solutions. With chemical anchoring, the cleaning of the hole enables more effective anchoring through the absence of dust. More particularly, the applicant has identified the presence of dust may prevent secure anchoring to a hole, especially where chemical anchoring is used as the chemical product may adhere to the dust rather than to the hole itself. Moreover it has been determined by the applicant that it would be beneficial for there to be provided a readily accessible apparatus for providing a procedure for cleaning of a drilled hole in preparation for chemical and all mechanical anchoring.

Chemical anchoring may include a chemical settable material as well as a device to be secured in the whole is a threaded rod or reinforcing bar. Examples mechanical anchoring may include expansion anchors and/or screw anchors—for example, anchors of the kind marketed using the branding of DynaBolts, AnkaScrews or similar.

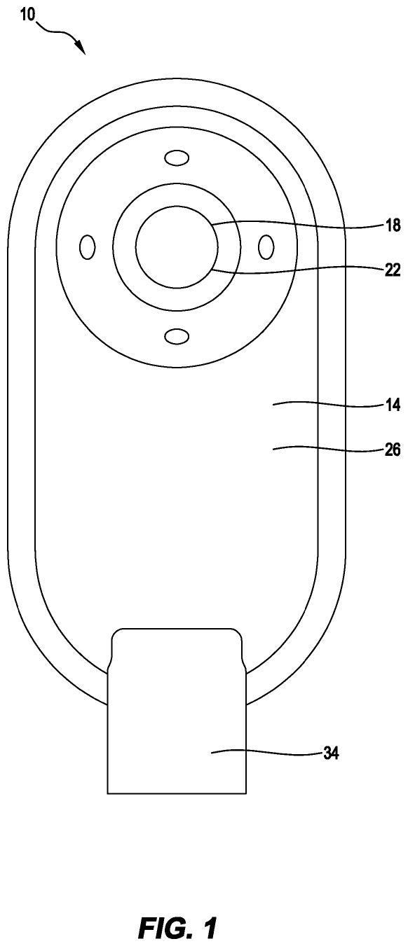

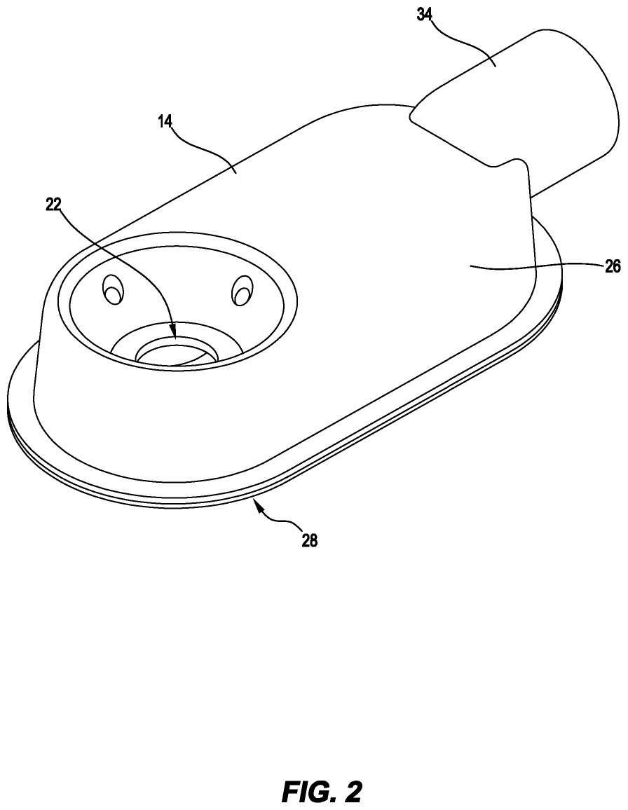

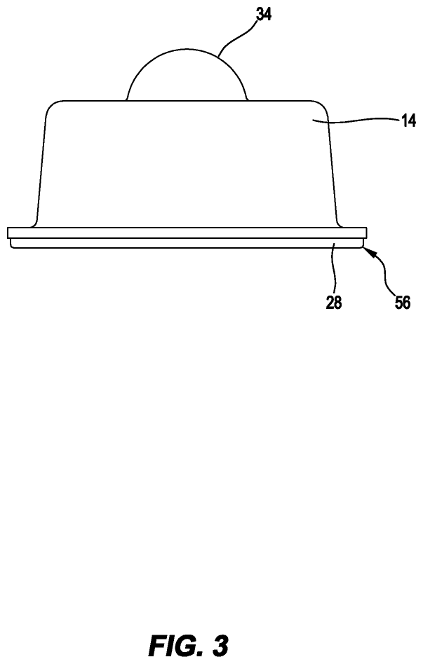

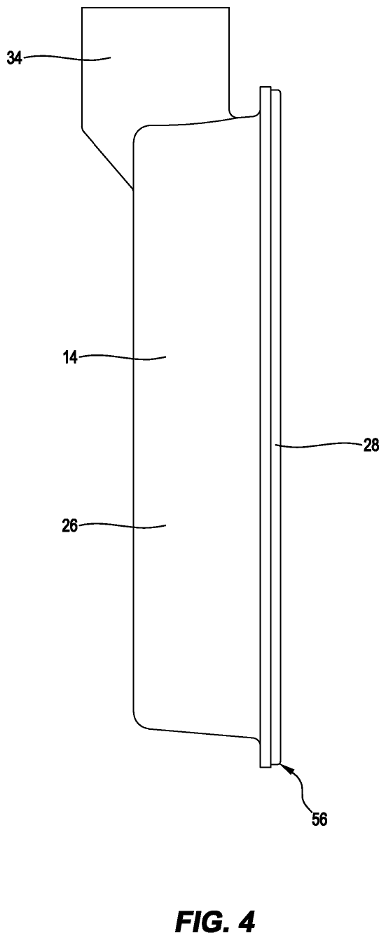

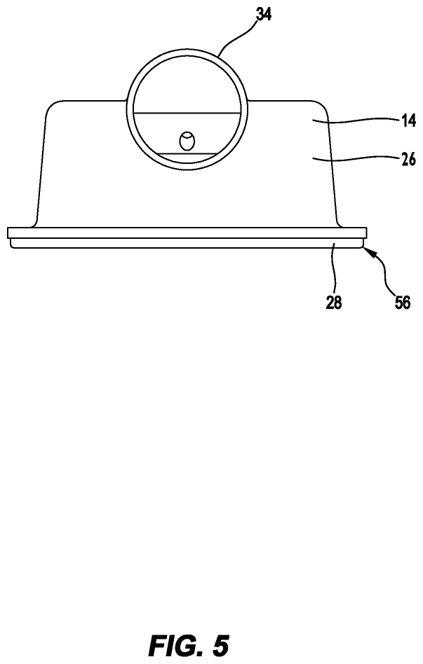

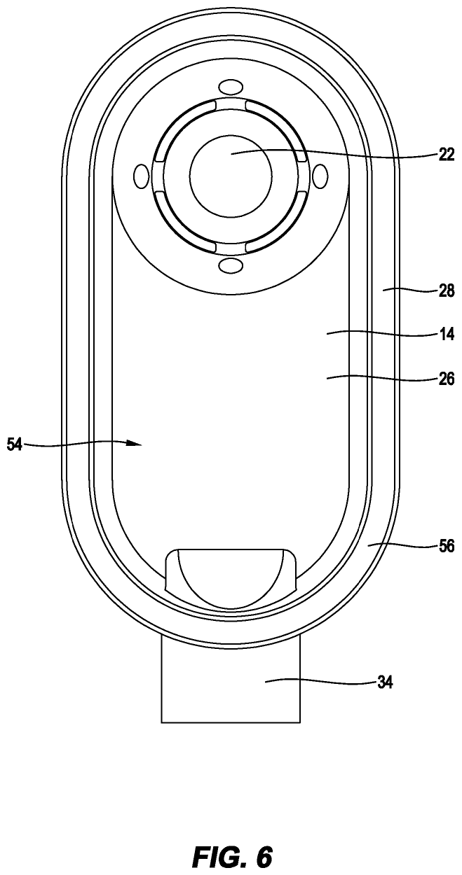

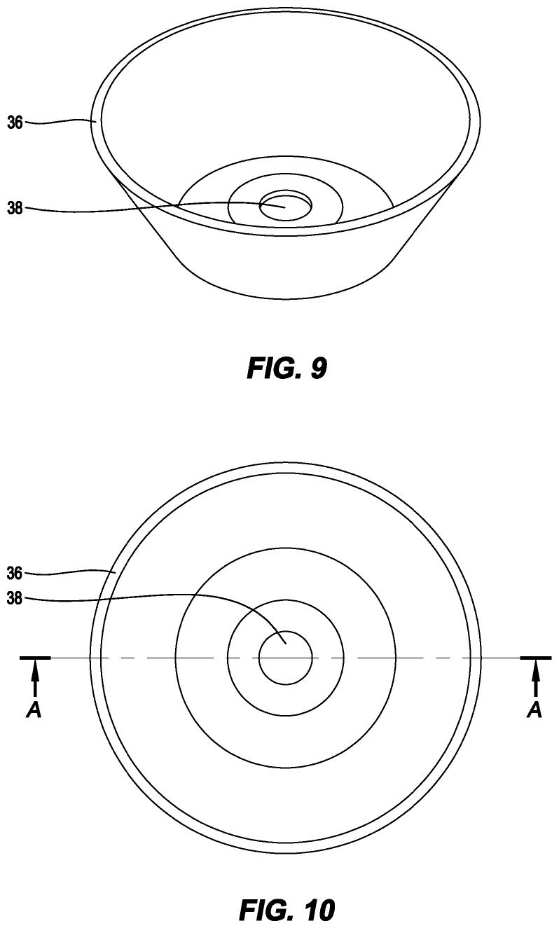

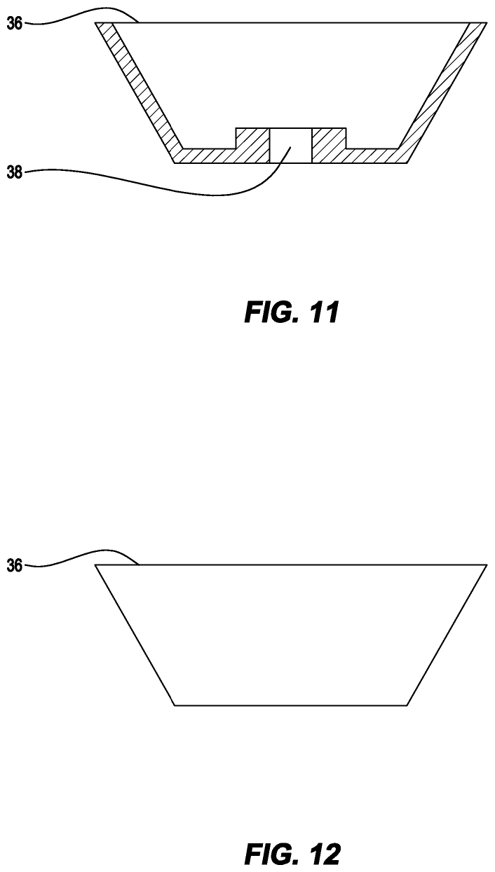

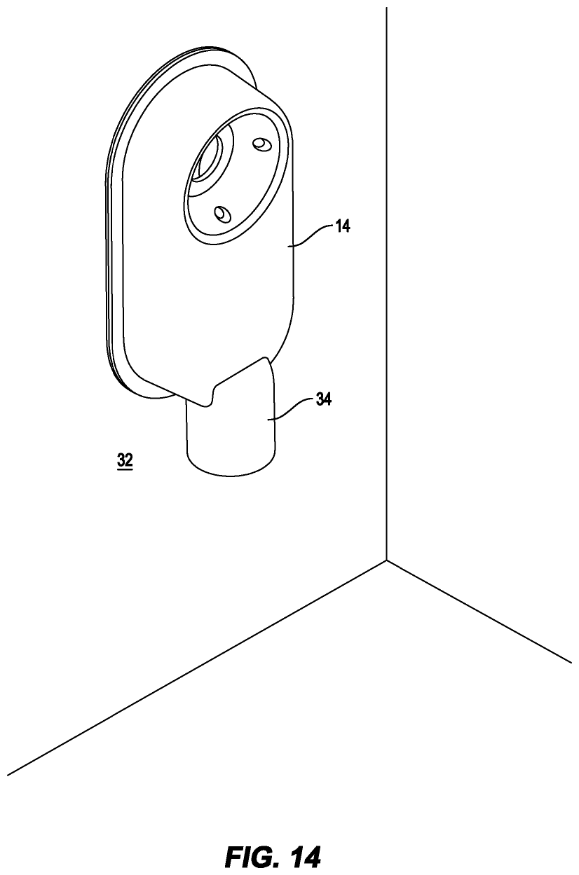

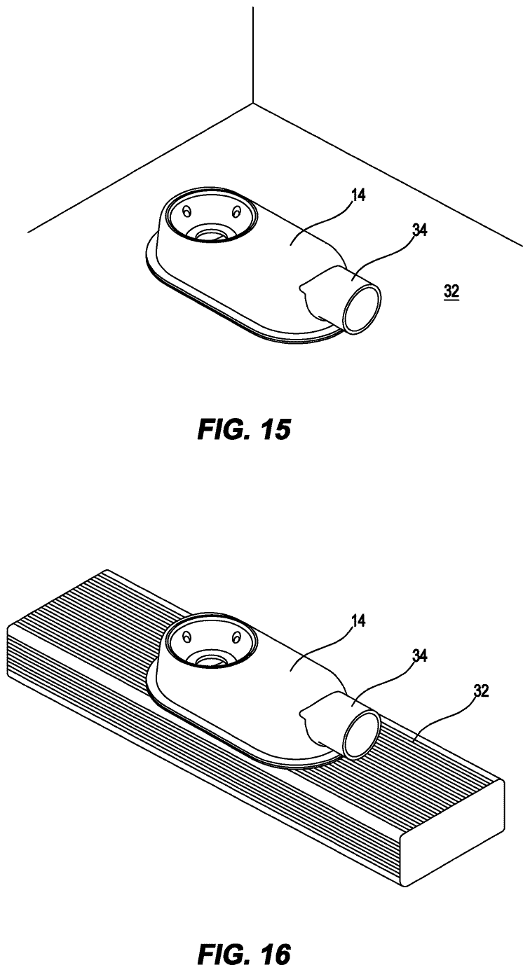

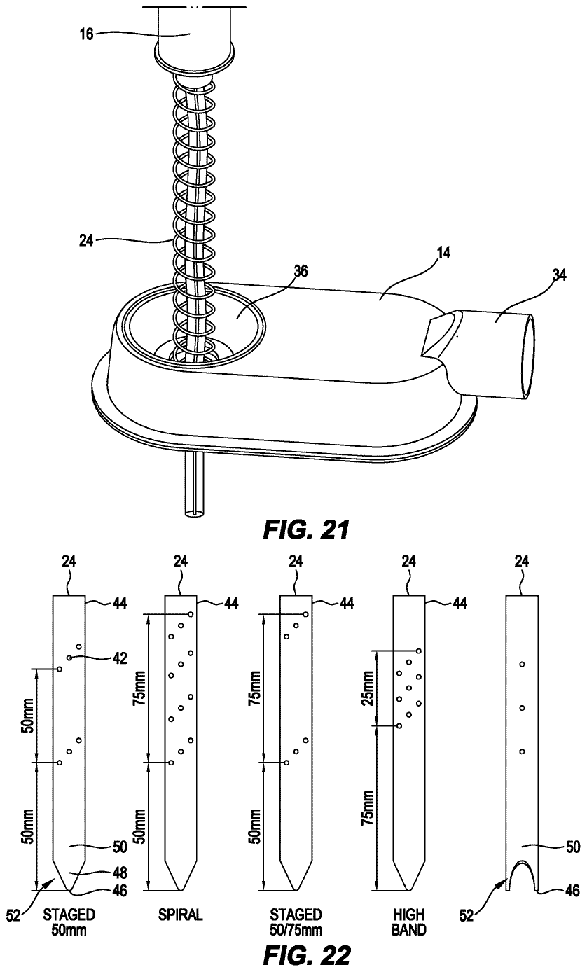

With reference to FIGS. 1 to 22 of the drawings, there is shown an apparatus 10 for dust removal from a drilled hole 12, including an adaptor 14 for coupling a vacuum to the drilled hole 12, and a pump 16 for pumping gas into the drilled hole 12 to blow dust from the drilled hole 12. The adaptor 14 includes a directing mechanism 18 for directing an outlet 20 of the pump 16 into the drilled hole 12.

In the example shown in the drawings, the directing mechanism 18 includes an aperture 22 in the adaptor 14 for allowing passage of a conduit 24 from the pump 16 into the drilled hole 12, and for guiding/directing the conduit 24 into the drilled hole 12. The adaptor 14 includes a body 26 having a base seal 28 for forming a seal against a surface 30 of a substrate 32 in which the hole 12 is drilled. The body 26 includes an outlet coupling 34 for coupling to a vacuum.

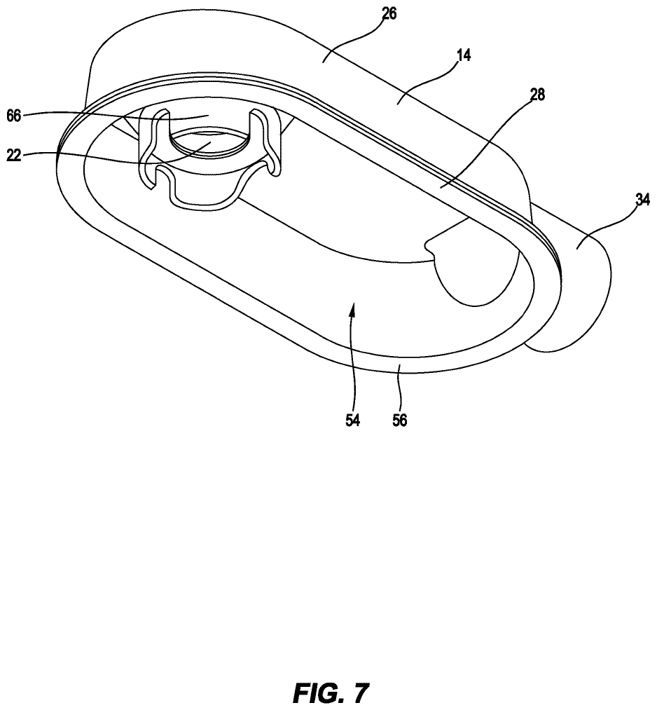

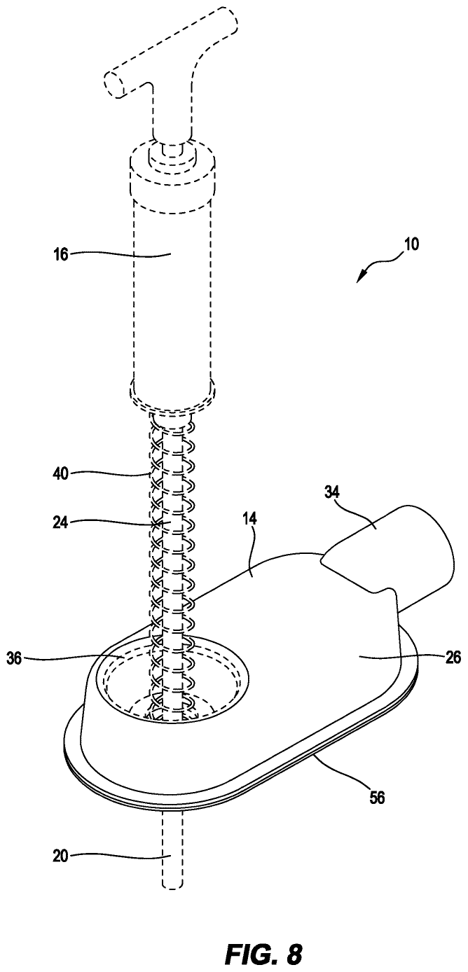

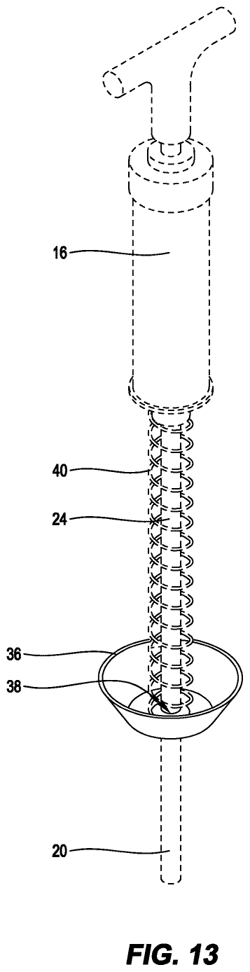

The apparatus 10 may include a removable cup 36 (see FIGS. 8 to 13) arranged to be seated against the body 26, the removable cup 36 having a central aperture 38 arranged to surround the conduit 24 from the pump 16. As can be seen in FIG. 8 and FIG. 13, the apparatus 10 may include a compression spring 40 around the conduit 24, the spring 40 being arranged to act against the removable cup 36 so as to bias the cup 36 in its seated arrangement against the body 26.

With reference to FIG. 22, the conduit 24 may be provided with side apertures 42 formed in a side wall 44 of the conduit. The side apertures 42 are spaced from a tip 46 of the conduit 24, and may be provided in different versions with a range of patterns and spacings.

The conduit 24 may have a main outlet 48 at a distal end portion 50 of the conduit 24. As shown in FIG. 22, the distal end portion 50 of the conduit 24 may have at least one cutaway 52 to prevent blockage of the conduit 24 against an end of the drilled hole 12.

The conduit 24 may be rigid and substantially linear, for example, formed as a rigid metallic tube.

The side apertures 42 may be arranged at spaced intervals along the length of a portion of the conduit 24. As shown in FIG. 22, the side apertures 42 may be arranged in a staged and/or spiral arrangement. For example, from left to right, FIG. 22 shows a first conduit 24 in which the side apertures 42 are staged at a 50 mm distance from the tip 46 and at another 50 mm (100 mm in total) from the tip 46; a second conduit 24 has the side apertures 42 arranged in a spiral configuration beginning at a location 50 mm from the tip 46 and extending to a location 125 mm from the tip 46; a third conduit 24 has sets of side apertures 42 which are staged, with a first stage at a distance 50 mm from the tip 46 and a second stage at a location 125 mm from the tip 46; a fourth conduit 24 has a high band set of side apertures 42 arranged to extend from a location 75 mm from the tip 46 to a location 100 mm from the tip 46; and a fifth conduit 24 having a series of spaced side apertures 42 in a linear arrangement along a length of a portion of the conduit 24.

As will be appreciated from the above, the side apertures 42 may be arranged at a distance from the distal tip 46 of approximately 50 mm, 75 mm, 100 mm and/or 125 mm.

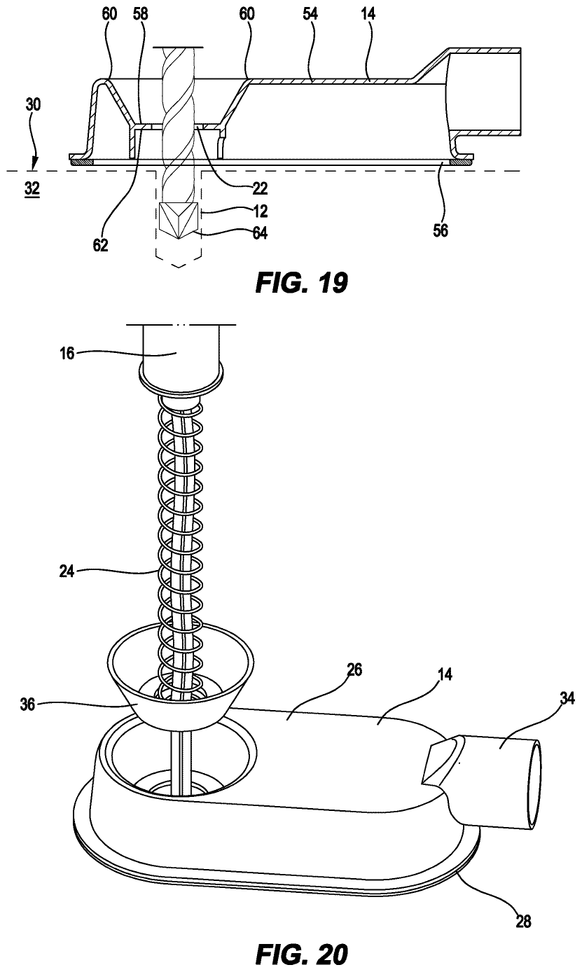

As seen in FIG. 7 and FIG. 19, the body 26 defines a vacuum suction chamber 54 whereby the outlet coupling 34 is in fluid communication with a foot 56 of the body 26 such that the body 26 is held in place against the substrate 32 by virtue of the vacuum.

Another aspect of the present disclosure provides a method of drilling a hole 12 in a substrate 32. Specifically, the method of drilling a hole 12 in a substrate 32 includes the steps of providing an apparatus 10 including an adaptor 14 and a pump 16; coupling an outlet coupling 34 of the adaptor 14 to a vacuum; placing a foot 56 of the adaptor 14 to rest on a surface 30 of the substrate 32; holding the adaptor 14 in place against the substrate 32 by operating the vacuum; arranging the pump 16 such that a conduit 24 of the pump 16 extends through a body 26 of the adaptor 14 and terminates in the drilled hole 12; and operating the pump 16 to blow dust from the drilled hole 12 such that said dust is fed through the outlet coupling 34 by virtue of the vacuum.

With reference to FIG. 19, in one form, prior to the step of operating the pump 16, the method further includes the step of using a drill with a drill bit 64 of the drill extending through the aperture 22 of the adaptor 14 so as to form the drilled hole 12 in the substrate 32. The method may further include a step of blowing gas from the pump 16 through side apertures 42 formed in a side wall 44 of the conduit 24 so as to blow dust from a side wall of the drilled hole 12.

Yet another aspect of the present disclosure provides an apparatus 10 for dust removal from a drilled hole 12 formed in a substrate 32, the apparatus 10 including an adaptor 14 for coupling a vacuum to the drilled hole 12. The adaptor 14 includes a foot 56 for standing on a surface 30 of the substrate 32 and the adaptor 14 includes an outlet coupling 34 for coupling to the vacuum. The adaptor 14 has a body 26 defining a suction chamber 54, and the body 26 is provided with a lowered platform having an aperture formed therein, the lowered platform 58 (see FIG. 19) being lowered from a surrounding portion 60 of the body 26 toward the foot 56 so as to improve visibility during drilling of the hole 12. In particular, the proximity of the lowered platform 58 to the work surface and the size of the aperture 22 (relatively large when compared with a size of a drill bit 64) improves visibility during drilling and/or cleaning.

Also, as can be seen clearly in FIG. 1, there are four perimeter holes surrounding the aperture 22, based evenly around the aperture 22. These perimeter holes allow air in during a drilling operation (when the removable cup 36 is not required), but are closed off by the removable cup 36 during the cleaning operation. The removable cup 36 may not be a perfect fit so as to intentionally still allow some flow through the perimeter holes. This relative blocking of the perimeter holes may increase the intensity of the vacuum to ensure that all dust is removed during the cleaning operation when the dust is being blown from the drilled hole 12. The compression spring 40 may not be essential where the vacuum is sufficient for holding the removable cup 36 in place.

The lowered platform 58 may be provided with a rigid seating portion 62 around the aperture 22 for seating a removable cup 36.

As will be appreciated from the above, examples of the present disclosure may eliminate airborne dust during the drilling and cleaning process, specifically the process of drilling a hole and cleaning the drilled hole of dust. Examples of the present disclosure may also eliminate the need to brush the hole, removing this step entirely.

In an example of the present disclosure, the apparatus 10 may be used by connecting a vacuum to the base unit (adaptor 14), drilling the hole, inserting a specially configured pump 16 through the adaptor 14 and into the drilled hole 12, operating the pump 16 one or more times, and removing the apparatus 10 such that the hole 12 is clean and ready to use.

Advantageously, examples of the present disclosure may:
eliminate airborne dust;
utilise a relatively low powered portable vacuum (tested with battery operated vacuum);
the adaptor can be used for any small diameter drilling even when hole cleaning is not required;
the adaptor may be held in place via a vacuum suction chamber;
the pump 16 may have a specially design hard conduit tube 24 (not a soft tube like existing pumps); and
ensure that no dust escapes during the drilling or cleaning process.

With reference to FIGS. 17 to 21, the adaptor 14 may be configured to have an opening which allows improved visibility of the drilling location by being closer to the working surface 30 by virtue of the lowered platform 58 around the aperture 22 through which the working surface 30 and the hole 12 can be viewed.

The removable cup 36 may be configured to ‘seat’ with the pump 16, particularly by virtue of the compression spring 40 which made by us the removal cup 36 into a seated configuration against the body 26 of the adaptor 14. Also, the tip 46 of the conduit 24 is configured to stop the possibility of the conduit tube 24 sealing on the bottom of the hole 12 by virtue of the one or more cutaways 52. The side apertures 42 in the conduit tube 24 may be configured to cause turbulence towards a top of the hole 12, assisting with cleaning of a wall of the hole 12, especially in deeper holes.

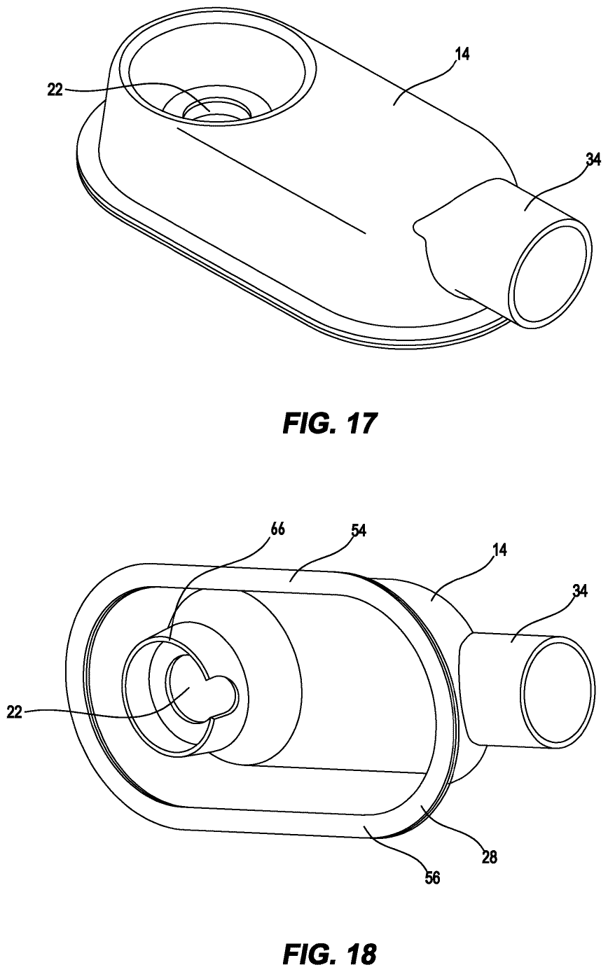

With reference to FIG. 18, it can be seen that there is formed a cylinder 66 which dependents beneath the aperture 22, the cylinder 66 in the example shown having one slot (compared with the example shown in FIG. 7 in which the cylinder 66 has four slots). The slots are provided for the purpose of airflow. It has been determined by the applicant that the four slot cylinder 66 of FIG. 7 may be preferable to the single slot cylinder 66 of FIG. 18 for the purpose of ensuring a uniform spread of airflow which prevents build-up of dust on surfaces.

Advantageously, the adaptor is configured with a single vacuum cavity, without underside divisions into multiple chambers, which assists in avoiding unwanted build up of dust in underside cavities. The single internal cavity has no catchment areas to promote clearance of dust via vacuum attachment.

With regard to the vacuum, the applicant has determined that it may be beneficial to the utility of examples of the present disclosure to arrange the apparatus such that it is able to achieve the required performance using a battery-operated vacuum. This means that it can then be used on powered and non-powered construction sites. Examples of vacuums that run on standard tool battery platforms may be used. Tradespeople may then buy a vacuum that runs on their existing battery platform. Other examples may use a vacuum being wired to a fixed power outlet.

While various embodiments of the present disclosure have been described above, it should be understood that they have been presented by way of example only, and not by way of limitation. It will be apparent to a person skilled in the relevant art that various changes in form and detail can be made therein without departing from the spirit and scope of the present disclosure. Thus, the present disclosure should not be limited by any of the above described exemplary embodiments.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### LIST OF REFERENCE NUMERALS

Apparatus for dust removal from a drilled hole 10
Drilled hole 12
Adaptor 14
Pump 16
Directing mechanism 18
Outlet 20
Aperture 22
Conduit 24
Body 26
Base seal 28
Surface 30
Substrate 32
Outlet coupling 34
Removable cup 36
Central aperture 38
Compression spring 40
Side apertures 42
Side wall 44
Tip 46
Main outlet 48
Distal end portion 50
Cutaway 52
Vacuum suction chamber 54
Foot 56
Lowered platform 58
Surrounding portion 60
Rigid seating portion 62
Drill bit 64
Cylinder 66

1-21. (canceled)

22: An apparatus for dust removal from a drilled hole, the apparatus comprising:
an adaptor configured to couple a vacuum to the drilled hole, the adaptor including a directing mechanism; and
a pump including an outlet that is connectable to the directing mechanism and through which the pump can cause gas to be directed into the drilled hole to blow dust from the drilled hole.

23: The apparatus of claim 22, wherein the directing mechanism defines aperture, wherein a conduit of the pump can extend through the aperture.

24: The apparatus of claim 23, wherein the adaptor includes a body having a base seal configured to form a seal against a surface of a substrate in which the hole is drilled.

25: The apparatus of claim 24, wherein the body includes an outlet coupling configured to couple to the vacuum.

26: The apparatus of claim 24, which includes a removable cup arranged to be seated against the body, the removable cup defining a central aperture and configured to surround the conduit from the pump.

27: The apparatus of claim 26, which includes a compression spring around the conduit, the spring being configured to act against the removable cup so as to bias the cup in a seated arrangement against the body.

28: The apparatus of claim 23, wherein the conduit includes a side wall that defines side apertures formed.

29: The apparatus of claim 28, wherein the side apertures are spaced from a tip of the conduit.

30: The apparatus of claim 28, wherein the side apertures are arranged at spaced intervals along the length of a portion of the conduit.

31: The apparatus of claim 34, wherein the side apertures are arranged in a staged and/or spiral arrangement.

32: The apparatus claim 35, wherein two of the side apertures are arranged at distances from a distal tip of the conduit, wherein the distances are two of 50 mm, 75 mm, 100 mm and/or 125 mm.

33: The apparatus of claim 23, wherein the conduit includes a main outlet at a distal end portion of the conduit.

34: The apparatus of claim 33, wherein the distal end portion of the conduit defines a cutaway configured to prevent blockage of the conduit against an end of the drilled hole.

35: The apparatus of claim 23, wherein the conduit is rigid.

36: The apparatus of claim 32, wherein the conduit is substantially linear.

37: The apparatus of claim 25, wherein the body defines a vacuum suction chamber whereby the outlet coupling is in fluid communication with a foot of the body such that the body is held in place against the substrate by air drawn into the vacuum.

38: An apparatus for dust removal from a drilled hole formed in a substrate, the apparatus comprising:
an adaptor configured couple a vacuum to the drilled hole, wherein the adaptor includes:
a foot configured to stand on a surface of the substrate,
an outlet coupling configured to couple to the vacuum, and
a body defining a suction chamber, and wherein the body includes a lowered platform defining an aperture, the lowered platform being lowered from a surrounding portion of the body toward the foot to provide visibility during drilling of the hole.

39: The apparatus of claim 38, wherein the platform includes a rigid seating portion around the aperture and configured to seat a removable cup.
